(19) United States
(12) Patent Application Publication
(10) Pub. No.: US 2009/0109168 A1
(43) Pub. Date: Apr. 30, 2009

(54) BACKLIGHT DRIVER AND LIQUID CRYSTAL DISPLAY DEVICE INCLUDING THE SAME

(76) Inventors: Sang-gil LEE, Seoul (KR); Seung-hwan Moon, Yongin-si (KR); Ki-chan Lee, Cheonan-si (KR)

Correspondence Address: Haynes and Boone, LLP;IP Section, 2323 Victory Avenue, SUITE 700, Dallas, TX, 75219, US

(21) Appl. No.: 12/247,826

(22) Filed: Oct. 8, 2008

(30) Foreign Application Priority Data
Oct. 30, 2007 (KR) 10-2007-0109656

(51) Int. Cl. G09G 3/18

(52) U.S. Cl. 345/102

(57) ABSTRACT

A backlight driver and liquid crystal display device including the same are disclosed. The backlight driver, in accordance with an embodiment, includes a driving-voltage-generating unit supplying a driving voltage to a light-emitting unit, or cutting off the supply of the driving voltage to the light-emitting unit, in response to a pulse width modulation signal; a pulse-width-modulation-signal-generating unit supplying the pulse width modulation signal to the driving-voltage-generating unit, and stopping its operation when an error occurs in the light-emitting unit; and an automatic reset unit supplying a reset signal to the pulse-width-modulation-signal-generating unit, when the pulse-width-modulation-signal-generating unit stops its operation, to restart the operation of the pulse-width-modulation-signal-generating unit.

### CROSS REFERENCE TO RELATED APPLICATION

This application claims priority from Korean Patent Application No. 10-2007-0109656 filed on Oct. 30, 2007 in the Korean Intellectual Property Office, the disclosure of which is incorporated herein by reference in its entirety.

### BACKGROUND

1. Technical Field

The present invention relates generally to a backlight driver and a liquid crystal display device including the same.

2. Description of the Related Art

In general, liquid crystal display devices include a liquid crystal panel assembly having a first display panel provided with pixel electrodes, a second display panel provided with a common electrode, and a liquid crystal layer that has dielectric anisotropy and is interposed between the first display panel and the second display panel. An electric field is formed between the pixel electrodes and the common electrode, and light passing through the liquid crystal panel assembly is controlled by adjusting the electric field, thereby displaying a desired image.

Since such a liquid crystal display device is not a self-emission display device, the liquid crystal display device is provided with a plurality of light-emitting elements and a backlight driver for controlling the operations of the light-emitting elements. The backlight driver receives optical data for brightness from a timing controller, and controls the operations of the light-emitting elements according to the optical data.

In particular, in recent years, in many cases, the backlight driver has been provided with a function for protecting the liquid crystal display device from erroneous operation. That is, when errors occur in the light-emitting element (for example, due to an over-voltage, an over-current, or noise), the operation of the backlight driver stops. When the operation of the backlight driver stops, a user needs to turn on a power supply for the backlight driver in order to restart the operation of the backlight driver. Even when the operation of the backlight driver stops due to a very small amount of noise, the user needs to turn on the power supply for the backlight driver.

### SUMMARY

Systems and methods are disclosed, in accordance with one or more embodiments, to provide a backlight driver having an automatic reset function. For example in accordance with an embodiment, a liquid crystal display device is disclosed having an automatic reset function.

According to an aspect of an embodiment of the invention, there is provided a backlight driver comprising a driving-voltage-generating unit supplying a driving voltage to a light-emitting unit, or cutting off the supply of the driving voltage to the light-emitting unit, in response to a pulse width modulation signal; a pulse-width-modulation-signal-generating unit supplying the pulse width modulation signal to the driving-voltage-generating unit, and stopping its operation when an error occurs in the light-emitting unit; and an automatic reset unit supplying a reset signal to the pulse-width-modulation-signal-generating unit, when the pulse-width-modulation-signal-generating unit stops its operation, to restart the operation of the pulse-width-modulation-signal-generating unit.

According to another aspect of an embodiment of the invention, there is provided a backlight driver comprising a driving-voltage-generating unit supplying a driving voltage to a light-emitting unit or cutting off the supply of the driving voltage to the light-emitting unit, in response to a pulse width modulation signal; a detecting unit detecting whether an error occurs in the light-emitting unit and outputting a detection signal; a pulse-generating unit receiving the detection signal and outputting a reset signal; a power supply voltage supplying unit supplying a power supply voltage and being turned on or off in response to the reset signal; and a signal-generating unit being turned on when the power supply voltage is equal to or higher than a specific voltage, receiving optical data, and outputting a pulse width modulation signal corresponding to the optical data.

According to still another aspect of an embodiment of the invention, there is provided a liquid crystal display device comprising a liquid crystal panel comprising a plurality of display blocks; a light-emitting unit emitting light to the liquid crystal panel and comprising a plurality of light-emitting blocks corresponding to the plurality of display blocks; a plurality of driving-voltage-generating units each of which supplies a driving voltage to the corresponding light-emitting block or cuts off the supply of the driving voltage to the corresponding light-emitting block in response to a pulse width modulation signal; a plurality of pulse-width-modulation-signal-generating units each of which supplies the pulse width modulation signal to the corresponding driving-voltage-generating unit, and stops its operation when an error occurs in the corresponding light-emitting block; and a plurality of automatic reset units each of which supplies a reset signal to the corresponding pulse-width-modulation-signal-generating unit when the pulse-width-modulation-signal-generating unit stops its operation, to restart the operation of the pulse-width-modulation-signal-generating unit.

Details of other embodiments are included in the detailed description and the drawings.

### BRIEF DESCRIPTION OF THE DRAWINGS

The above and other features and advantages of embodiments of the present invention will become apparent by describing in detail with reference to the attached drawings in which:

FIG. 1 is a block diagram illustrating a liquid crystal display device according to an embodiment of the invention;

FIG. 2 is an equivalent circuit diagram of one pixel;

FIG. 3 is a conceptual diagram illustrating the operation of the backlight driver shown in FIG. 1;

FIG. 4 is a block diagram illustrating a light-emitting unit of the backlight driver according to an embodiment of the invention;

FIG. 5 is a circuit diagram illustrating an example of the structure of the driving-voltage-generating unit shown in FIG. 4;

FIG. 6 is a block diagram illustrating an example of the structure of the pulse-width-modulation-signal-generating unit shown in FIG. 4;

FIG. 7 is a circuit diagram illustrating an example of the structure of the signal-generating circuit and the over-voltage protection circuit shown in FIG. 6;

FIG. 8 is a block diagram illustrating an example of the structure of the automatic reset unit shown in FIG. 4; and

FIG. 9 is a block diagram illustrating the structure of a backlight driver and a light-emitting unit according to another embodiment of the invention.

### DETAILED DESCRIPTION

Advantages and features of embodiments of the present invention and methods of accomplishing the same may be understood more readily by reference to the following detailed description and the accompanying drawings. The present invention may, however, be embodied in many different forms and should not be construed as being limited to the embodiments set forth herein. Rather, these embodiments are provided so that this disclosure will be thorough and complete and will fully convey the concept of embodiments of the invention to those skilled in the art, and the present invention will only be defined by the appended claims. Like reference numerals refer to like elements throughout the specification.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, and/or sections, these elements, components, and/or sections should not be limited by these terms. These terms are only used to distinguish one element, component, or section from another element, component, or section. Thus, a first element, component, or section discussed below could be termed a second element, component, or section without departing from the teachings of the present invention.

The terminology used herein is for the purpose of describing exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless explicitly stated otherwise, all of the terminologies (including technical and scientific terminologies) used herein may be used as meaning that those skilled in the art can commonly understand. Furthermore, terminologies defined in ordinary dictionaries should not be ideally or excessively construed, unless explicitly stated otherwise.

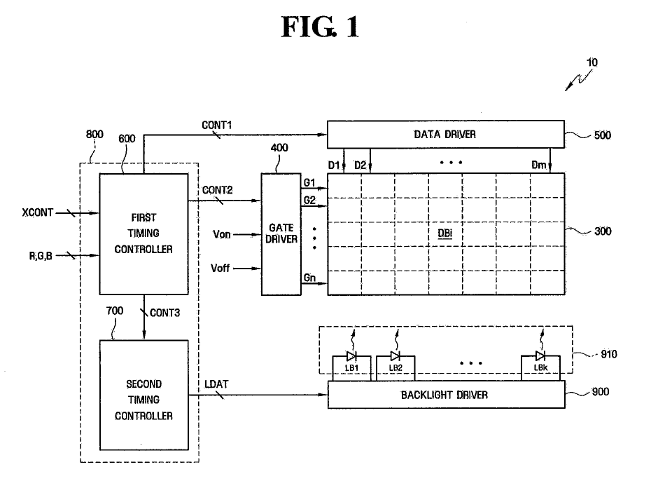

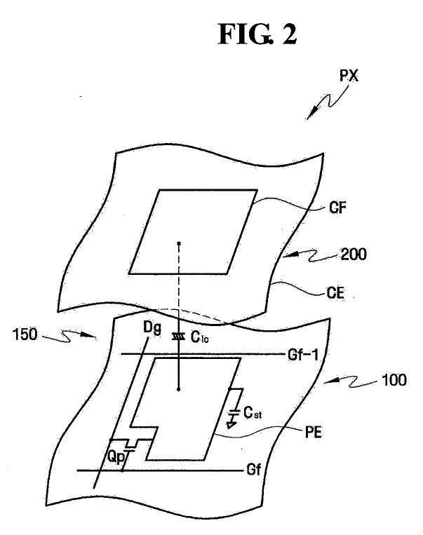

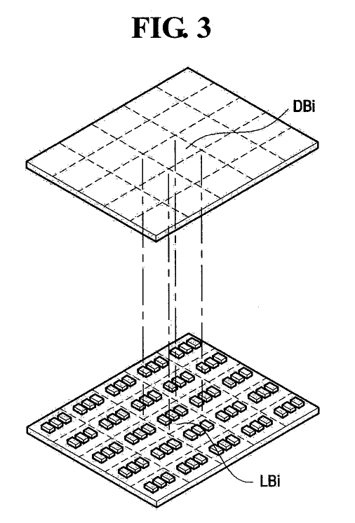

Hereinafter, a backlight driver and a liquid crystal display device including the same will be described with reference to FIGS. 1 to 3. FIG. 1 is a block diagram illustrating a liquid crystal display device according to an embodiment of the invention, FIG. 2 is an equivalent circuit diagram of one pixel, and FIG. 3 is a conceptual diagram illustrating the operation of a backlight driver shown in FIG. 1.

Referring to FIG. 1, a liquid crystal display device 10 includes a liquid crystal panel assembly 300, a gate driver 400, a data driver 500, a timing controller 800, a backlight driver 900, and a light-emitting unit 910. The timing controller 800 may be functionally divided into a first timing controller 600 and a second timing controller 700. The first timing controller 600 may control images displayed on the liquid crystal panel assembly 300, and the second timing controller 700 may control the backlight driver 900. The first timing controller 600 and the second timing controller 700 may not be physically separated from each other.

The liquid crystal panel assembly 300 includes a plurality of display signal lines G1 to Gn and D1 to Dm and a plurality of pixels (not shown) connected to the display signal lines in an equivalent circuit diagram. The display signal lines G1 to Gn and D1 to Dm include a plurality of gate lines G1 to Gn and a plurality of data lines D1 to Dm.

The liquid crystal panel 300 includes a plurality of pixels, and FIG. 2 is an equivalent circuit diagram of one pixel. For example, a pixel PX connected to an f-th (f=1 to n) gate line Gf and a g-th (g=1 to m) data line Dg includes a switching element Qp connected to the gate line Gf and the data line Dg, and a liquid crystal capacitor Clc and a storage capacitor Cst connected to the switching element Qp. The liquid crystal capacitor Clc includes a pixel electrode PE of the first display panel 100 and a common electrode CE of the second display panel 200. Color filters CF are formed in some regions of the common electrode CE.

The data driver 500 shown in FIG. 1 receives data control signals CONT1 from the first timing controller 600, and applies image data voltages to the data lines D1 to Dm. The data control signals CONT1 include R, G, and B image signals and signals for controlling the operation of the data driver 500. The signals for controlling the operation of the data driver 500 may include a horizontal start signal for starting the operation of the data driver 500 and an output instruction signal for instructing the output of the image data voltage.

The gate driver 400 receives gate control signals CONT2 from the first timing controller 600 and supplies gate signals to the gate lines G1 to Gn. The gate signal is composed of a combination of a gate-on voltage Von and a gate-off voltage Voff supplied from a gate on/off voltage generator (not shown). The gate control signals CONT2 are used to control the operation of the gate driver 400, and may include a vertical start signal for starting the operation of the gate driver 400, a gate clock signal for determining the output timing of the gate-on voltage, and an output enable signal for determining the pulse width of the gate-on voltage.

The gate driver 400 or the data driver 500 may be directly mounted on the liquid crystal panel assembly 300 in the form of a plurality of driving integrated circuit chips, or it may be mounted on a flexible printed circuit film (not shown) and then adhered to the liquid crystal panel assembly 300 in the form of a tape carrier package. Alternatively, the gate driver 400 or the data driver 500 may be integrated into the liquid crystal panel assembly 300 together with the display signal lines G1 to Gn and D1 to Dm and the switching elements Qp.

The first timing controller 600 receives R, G, and B signals (labeled R, G, and B) and control signals XCONT for controlling the display thereof from an external graphic controller (not shown). The first timing controller 600 generates the data control signal CONT1 and the gate control signal CONT2 on the basis of the R, G, and B signals (R, G, and B) and the control signals XCONT. The control signals XCONT include, for example, a vertical synchronization signal Vsync, a horizontal synchronization signal Hsync, a main clock signal Mclk, and a data enable signal DE. The first timing controller 600 outputs a backlight control signal CONT3 to the second timing controller 700. The backlight control signal CONT3 may include optical data LDAT. The second timing controller 700 receives the backlight control signal CONT3 from the first timing controller 600, and outputs the optical data LDAT to the backlight driver 900.

The backlight driver 900 receives the optical data LDAT and applies a driving voltage to a plurality of light-emitting blocks LB1 to LBk to control the brightness of the plurality of light-emitting blocks LB1 to LBk. Each of the light-emitting blocks LB1 to LBk may include a plurality of light-emitting elements, and the light-emitting element may be an LED (light emitting diode). The brightness of each of the light-emitting blocks LB1 to LBk may be controlled according to the image displayed on the liquid crystal panel 300. For example, as shown in FIGS. 1 and 3, the liquid crystal panel 300 may be divided into a plurality of display blocks DB1 corresponding to the plurality of light-emitting blocks LB1 to LBk, and the brightness of each of the light-emitting blocks LB1 may be controlled according to the image displayed on the corresponding display block DB1.

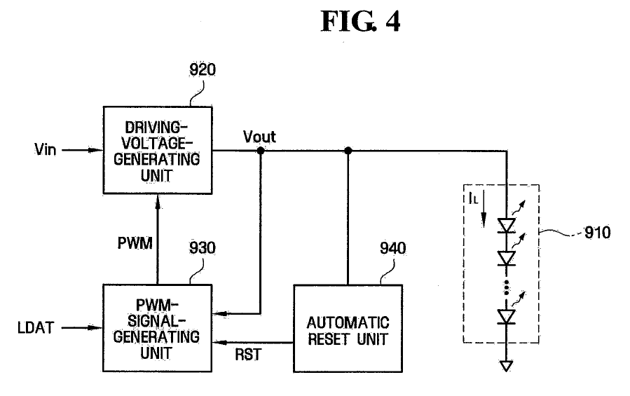

The backlight driver 900 according to this embodiment has an erroneous-operation-protection function and an automatic reset function. Specifically, when errors occur in the light-emitting blocks LB1 to LBk, the backlight driver 900 stops its operation and supplies no driving voltage to the light-emitting blocks LB1 to LBk. In this case, the backlight driver 900 may be automatically reset so that its operation may resume. This function will be described in detail with reference to FIGS. 4 to 8.

FIG. 4 is a block diagram illustrating the backlight driver 900 and the light-emitting unit 910 according to the present embodiment.

Referring to FIG. 4, the backlight driver 900 includes a driving-voltage-generating unit 920, a pulse-width-modulation-signal-generating unit 930, and an automatic reset unit 940.

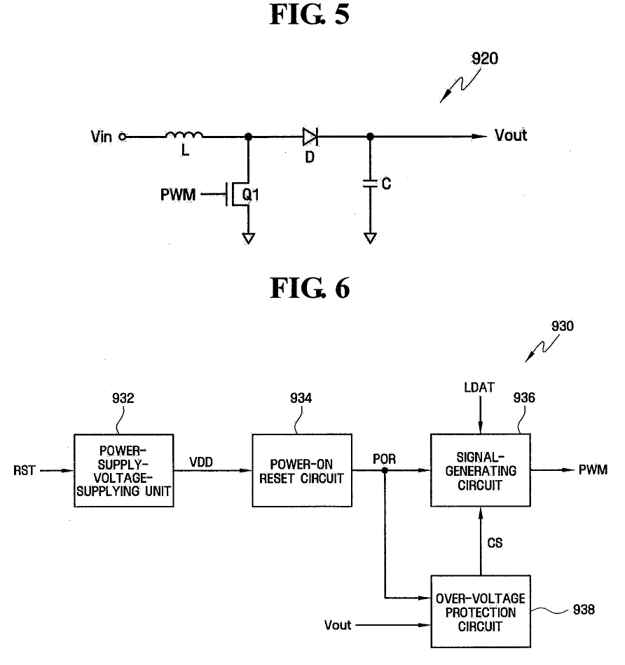

The driving-voltage-generating unit 920 is supplied with an input voltage Vin, and supplies the driving voltage Vout to the light-emitting unit 910 or cuts off (e.g., switches off) the supply of the driving voltage Vout to the light-emitting unit 910 in response to the pulse width modulation signal PWM. The circuit structure of the driving-voltage-generating unit 920 will be described below with reference to FIG. 5.

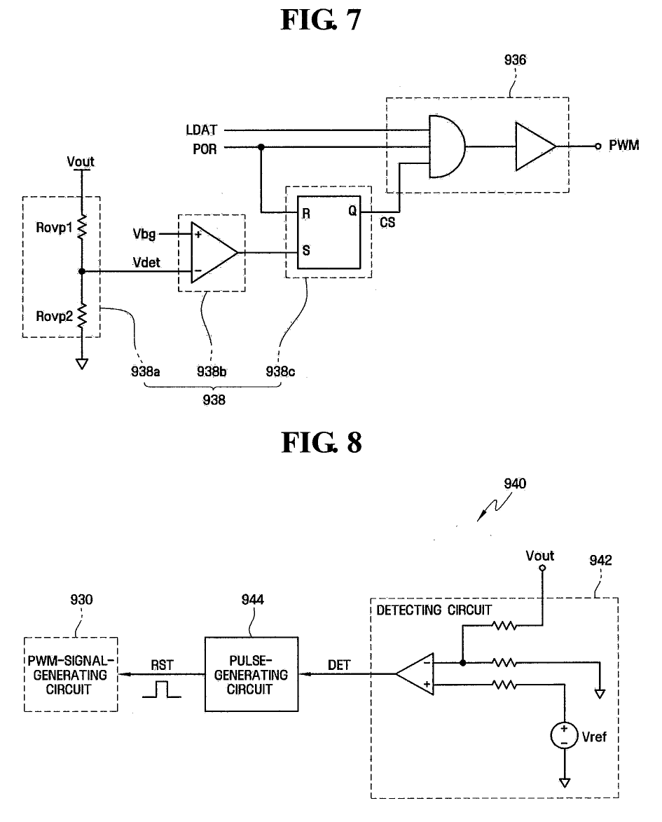

The pulse-width-modulation-signal-generating unit 930 receives the optical data LDAT and outputs a pulse width modulation signal PWM to the driving-voltage-generating unit 920. The configuration and circuit structure of the pulse-width-modulation-signal-generating unit 930 will be described below with reference to FIGS. 6 and 7.

Next, the operation of the pulse-width-modulation-signal-generating unit 930 will be described below. In the period in which the pulse width modulation signal PWM is at a high level, the driving-voltage-generating unit 920 applies the driving voltage Vout to the light-emitting unit 910 to turn on the light-emitting unit 910. Therefore, a current IL flows through the light-emitting unit to emit light. On the other hand, in the period in which the pulse width modulation signal PWM is at a low level, the driving-voltage-generating unit 920 applies no driving voltage Vout to the light-emitting unit 910 to turn off the light-emitting unit 910. The time required to turn on the light-emitting unit 910 is determined according to whether the pulse width modulation signal PWM is in the high level period or the low level period. That is, when the time required to turn on the light-emitting unit 910 increases, the brightness also increases. Briefly, the duty ratio of the pulse width modulation signal PWM depends on the optical data LDAT, and the brightness depends on the duty ratio of the pulse width modulation signal PWM.

In the present embodiment of the invention, the pulse-width-modulation-signal-generating unit 930 has an erroneous-operation-protection function. That is, when an error occurs in the light-emitting unit 910, the pulse-width-modulation-signal-generating unit 930 stops its operation and supplies no pulse width modulation signal PWM. For example, errors occur in the light-emitting unit 910 due to an over-voltage applied to the light-emitting unit 910, an over-current flowing through the light-emitting unit 910, and noise in the voltage applied to or the current flowing through the light-emitting unit 910. FIG. 4 shows the operation of the pulse-width-modulation-signal-generating unit 930 that stops according to whether an over-voltage is applied to the light-emitting unit 910. The pulse-width-modulation-signal-generating unit 930 stops its operation when the driving voltage Vout applied to the light-emitting unit 910 is higher than a specific voltage.

In the present embodiment of the invention, when the pulse-width-modulation-signal-generating unit 930 stops its operation, the automatic reset unit 940 supplies a reset signal RST to the pulse-width-modulation-signal-generating unit 930 to restart the pulse-width-modulation-signal-generating unit 930. That is, the automatic reset unit 940 has a function for automatically resetting the pulse-width-modulation-signal-generating unit 930. In the present embodiment of the invention, even when an error occurs in the light-emitting unit 910 and the pulse-width-modulation-signal-generating unit 930 stops its operation, it is unnecessary for the user to turn on a power supply (not shown) supplying a voltage to the pulse-width-modulation-signal-generating unit 930. Even when a very small amount of noise that has little effect on the operation is generated and the pulse-width-modulation-signal-generating unit 930 stops its operation, it is unnecessary for the user to turn on the power supply, which results in an improvement in user convenience. The structure of the automatic reset unit 940 will be described below with reference to FIG. 8.

FIG. 5 is a circuit diagram illustrating an example of the structure of the driving-voltage-generating unit shown in FIG. 4. FIG. 5 shows a boost converter as an example, but the invention is not limited thereto. For example, the driving-voltage-generating unit may be a different type of converter, such as a buck converter or a single ended primary inductor converter (SEPIC).

Referring to FIG. 5, the driving-voltage-generating unit 920 boosts an input voltage Vin to generate the driving voltage Vout required to operate the light-emitting blocks LB1 to LBk. The driving-voltage-generating unit 920 includes an inductor L, a diode D, a capacitor C, and a switching element Q1. Specifically, the driving-voltage-generating unit 920 includes the inductor L that is supplied with the input voltage Vin, the diode D having an anode connected to the inductor L and a cathode connected to an output terminal for the driving voltage Vout, the capacitor C connected between the cathode of the diode D and a ground terminal, and the switching element Q1 connected between the anode of the diode D and the ground terminal.

The operation of the driving-voltage-generating unit 920 will be described below. When the pulse width modulation signal PWM is at a high level, the switching element Q1 is turned on, and the current flowing through the inductor L gradually increases in proportion to the input voltage Vin applied to both ends of the inductor L according to current and voltage characteristics of the inductor L. When the pulse width modulation signal PWM is at a low level, the switching element Q1 is turned off, and the current flowing through the inductor L flows through the diode D. Then, the capacitor C is charged with a voltage according to the current and voltage characteristics of the capacitor C. As a result, the input voltage Vin is boosted to a predetermined voltage and the boosted voltage is output as the driving voltage Vout.

FIG. 6 is a block diagram illustrating an example of the structure of the pulse-width-modulation-signal-generating unit shown in FIG. 4, and FIG. 7 is a circuit diagram illustrating an example of the structures of the signal-generating circuit shown in FIG. 6 and an over-voltage protection circuit shown in FIG. 6.

Referring to FIGS. 6 and 7, the pulse-width-modulation-signal-generating unit 930 includes a power-supply-voltage-supplying circuit 932, a power-on reset circuit 934, a signal-generating circuit 936, and an over-voltage protection circuit 938.

The power-supply-voltage-supplying circuit 932 provides a power supply voltage VDD, and is turned on or off in response to a reset signal RST. In the period in which the reset signal RST is activated, the power-supply-voltage-supplying circuit 932 is turned off. On the other hand, in the period in which the reset signal RST is not activated, the power-supply-voltage-supplying circuit 932 is turned on.

The power-on reset circuit 934 is supplied with the power supply voltage VDD. When the power supply voltage VDD is higher than a specific voltage, the power-on reset circuit 934 supplies a power-on reset signal POR. Specifically, when the backlight driver is turned on, an external power supply voltage (not shown) is applied, and the power-supply-voltage-supplying circuit 932 uses the external power supply voltage to generate the power supply voltage VDD. The power-on reset signal POR is activated when the power supply voltage VDD is higher than a specific voltage, and indicates that the backlight driver can be normally operated.

The over-voltage protection circuit 938 is supplied with the driving voltage Vout applied to the light-emitting unit 910, and checks whether the driving voltage Vout is higher than a specific voltage. When the driving voltage Vout is higher than the specific voltage, the over-voltage protection circuit 938 activates a control signal CS. That is, the control signal CS indicates whether an over-voltage is applied to the light-emitting unit 910, and the activated control signal CS turns off the signal-generating circuit 936.

The over-voltage protection circuit 938 may include a voltage-dividing unit 938a, a comparing unit 938b, and a storage unit 938c. The voltage-dividing unit 938a includes a plurality of resistors Rovp1 and Rovp2, and divides the driving voltage Vout to generate a detection voltage Vdet. The comparing unit 938b compares the detection voltage Vdet with a reference voltage Vbg and outputs the comparison result. The storage unit 938c receives and stores the comparison result, and outputs the control signal CS corresponding to the stored information. The storage unit 938c may receive the power-on reset signal POR to be reset. That is, the storage unit 938c may be reset when the pulse-width-modulation-signal-generating unit 930 starts or restarts its operation. As shown in FIG. 7, the storage unit 938c may be a set-reset (SR) flip-flop, but the invention is not limited thereto. For example, the storage unit 938c may be a different type of flip-flop. Meanwhile, the over-voltage protection circuit 938 may compare the driving voltage Vout with the reference voltage Vbg, and output the comparison result to the storage unit 938c without the voltage-dividing unit 938a.

The signal-generating circuit 936 is turned on or off in response to the power-on reset signal POR and the control signal CS. In addition, the signal-generating circuit 936 receives the optical data LDAT and generates a pulse width modulation signal PWM corresponding to the optical data LDAT. As shown in FIG. 7, the signal-generating circuit 936 may include an AND gate for performing an AND operation on the optical data LDAT, the power-on reset signal POR, and the control signal CS, and a buffer for buffering an output signal from the AND gate.

FIG. 8 is a block diagram, in accordance with an embodiment, illustrating an example of the structure of the automatic reset unit shown in FIG. 4.

Referring to FIG. 8, the automatic reset unit 940 includes a detecting circuit 942 and a pulse-generating circuit 944.

The detecting circuit 942 detects whether an error has occurred in the light-emitting unit 910, and outputs a detection signal DET. FIG. 8 shows an example of the structure of the detecting circuit 942 for detecting whether an error occurs in the light-emitting unit 910. Specifically, the detecting circuit 942 compares the driving voltage Vout with the reference voltage Vref, and outputs the detection signal DET according to the comparison result.

The pulse-generating circuit 944 receives the detection signal DET, and outputs the reset signal RST for restarting the operation of the pulse-width-modulation-signal-generating unit 930. The pulse-generating circuit 944 may be, for example, a mono-stable multivibrator. The reset signal RST output from the mono-stable multivibrator is stable in the first state (for example, at a low level), and is unstable in the second state (for example, at a high level). Therefore, the reset signal RST changes from the first state to the second state in response to the detection signal DET and returns to the first state after a predetermined time has elapsed. That is, the reset signal RST is kept in an active state for a predetermined time.

Next, the operations of the pulse-width-modulation-signal-generating unit 930 and the automatic reset unit 940 will be described with reference to FIGS. 6 to 8.

When an error occurs in the light-emitting unit 910, the pulse-width-modulation-signal-generating unit 930 stops its operation, and the level of the driving voltage Vout is lowered. When the driving voltage Vout is lower than the reference voltage Vref, the detection signal DET changes from a low level to a high level. The pulse-generating circuit 944 receives the detection signal DET and outputs the reset signal RST that is kept in an active state for a predetermined period of time. While the activated reset signal RST is received, the power-supply-voltage-supplying circuit 932 is turned off. When the reset signal RST is activated again, the power-supply-voltage-supplying circuit 932 is turned on to generate the power supply voltage VDD. That is, the power-supply-voltage-supplying circuit 932 is turned off and then turned on in response to the reset signal RST. When the power supply voltage VDD is higher than a specific voltage, the power-on reset circuit 934 outputs the power-on reset signal POR. The over-voltage protection circuit 938 receives the power-on reset signal POR to be reset, and the signal-generating circuit 936 restarts its operation to output a pulse width modulation signal PWM corresponding to the optical data LDAT.

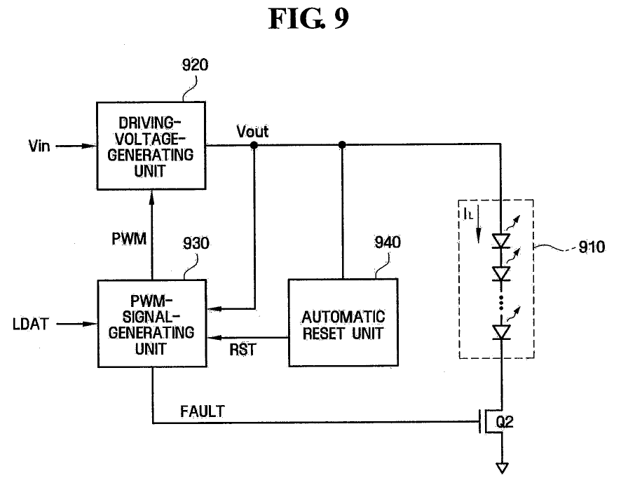

FIG. 9 is a block diagram illustrating a backlight driver and a light-emitting unit according to another embodiment of the invention.

Referring to FIG. 9, this embodiment differs from the above-described embodiment in that, when the operation of the light-emitting unit 910 stops due to an error, the pulse-width-modulation-signal-generating unit 930 outputs an error signal FAULT. The error signal FAULT turns off a switching element Q2 connected in series to the light-emitting unit 910. Therefore, when the operation of the light-emitting unit 910 stops due to an error, no current flows through the light-emitting unit 910. As a result, according to the present embodiment, it is possible to more stably control the current flowing through the light-emitting unit 910, as compared to the above-described embodiment.

In the present embodiment, the operations of the driving-voltage-generating unit 920, the pulse-width-modulation-signal-generating unit 930, and the automatic reset unit 940 are the same as those shown in FIG. 4, and thus a description thereof will not be repeated.

As described above, since the backlight driver and the liquid crystal display device including the same according to one or more embodiments of the invention have an automatic reset function, it is possible to improve the user friendliness of the LCD.

Although the various embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A backlight driver comprising:
a driving-voltage-generating unit supplying a driving voltage to a light-emitting unit, or cutting off the supply of the driving voltage to the light-emitting unit, in response to a pulse width modulation signal;
a pulse-width-modulation-signal-generating unit supplying the pulse width modulation signal to the driving-voltage-generating unit, and stopping its operation when an error occurs in the light-emitting unit; and
an automatic reset unit supplying a reset signal to the pulse-width-modulation-signal-generating unit, when the pulse-width-modulation-signal-generating unit stops its operation, to restart the operation of the pulse-width-modulation-signal-generating unit.

2. The backlight driver of claim 1, wherein the pulse-width-modulation-signal-generating unit stops its operation when an over-voltage is applied to the light-emitting unit.

3. The backlight driver of claim 1, wherein the automatic reset unit comprises:
a detecting circuit detecting whether an error occurs in the light-emitting unit and outputting a detection signal; and
a pulse-generating circuit receiving the detection signal and outputting the reset signal for restarting the operation of the pulse-width-modulation-signal-generating unit.

4. The backlight driver of claim 3, wherein the detecting circuit detects whether an over-voltage is applied to the light-emitting unit.

5. The backlight driver of claim 4, wherein the detecting circuit compares the driving voltage with a reference voltage, and outputs a detection signal according to the result of the comparison.

6. The backlight driver of claim 3, wherein the pulse-generating circuit is a mono-stable multivibrator.

7. The backlight driver of claim 1, wherein the pulse-width-modulation-signal-generating unit comprises:
a power-supply-voltage-supplying circuit supplying a power supply voltage, and being turned on or off in response to the reset signal;
a power-on reset circuit being supplied with the power supply voltage, and outputting a power-on reset signal when the power supply voltage is equal to or greater than a specific voltage; and
a signal-generating circuit being turned on or off in response to the power-on reset signal, receiving optical data, and outputting a pulse width modulation signal corresponding to the optical data.

8. The backlight driver of claim 7, wherein the pulse-width-modulation-signal-generating unit further comprises:
an over-voltage protection circuit comparing the driving voltage with the reference voltage and outputting a control signal to the signal-generating circuit according to the result of the comparison, and
wherein the signal-generating circuit is turned on or off in response to the control signal and the power-on reset signal, receives optical data, and outputs a pulse width modulation signal corresponding to the optical data.

9. The backlight driver of claim 8, wherein the over-voltage protection circuit comprises:
a comparing unit comparing the driving voltage and the reference voltage, and outputting the comparison result; and
a storage unit receiving and storing the comparison result, and outputting a control signal corresponding to the stored information.

10. The backlight driver of claim 9, wherein the storage unit is a flip-flop.

11. The backlight driver of claim 9, wherein the storage unit is reset when the pulse-width-modulation-signal-generating unit restarts its operation.

12. A backlight driver comprising:
a driving-voltage-generating unit supplying a driving voltage to a light-emitting unit or cutting off the supply of the driving voltage to the light-emitting unit, in response to a pulse width modulation signal;
a detecting unit detecting whether an error occurs in the light-emitting unit and outputting a detection signal;
a pulse-generating unit receiving the detection signal and outputting a reset signal;
a power supply voltage supplying unit supplying a power supply voltage and being turned on or off in response to the reset signal; and
a signal-generating unit being turned on when the power supply voltage is equal to or higher than a specific voltage, receiving optical data, and outputting a pulse width modulation signal corresponding to the optical data.

13. The backlight driver of claim 12, wherein the detecting unit detects whether an over-voltage is applied to the light-emitting unit.

14. A liquid crystal display device comprising:
a liquid crystal panel comprising a plurality of display blocks;
a light-emitting unit emitting light to the liquid crystal panel and comprising a plurality of light-emitting blocks corresponding to the plurality of display blocks;
a plurality of driving-voltage-generating units each of which supplies a driving voltage to the corresponding light-emitting block or cuts the supply of the driving voltage to the corresponding light-emitting block in response to a pulse width modulation signal;
a plurality of pulse-width-modulation-signal-generating units each of which supplies the pulse width modulation signal to the corresponding driving-voltage-generating unit, and stops its operation when an error occurs in the corresponding light-emitting block; and
a plurality of automatic reset units each of which supplies a reset signal to the corresponding pulse-width-modulation-signal-generating unit when the pulse-width-modulation-signal-generating unit stops its operation, to restart the operation of the pulse-width-modulation-signal-generating unit.

15. The liquid crystal display device of claim 14, wherein the pulse-width-modulation-signal-generating unit stops its operation when an over-voltage is applied to the light-emitting unit.

16. The liquid crystal display device of claim 14, wherein the automatic reset unit comprises:
a detecting circuit detecting whether an error occurs in the light-emitting unit and outputting a detection signal; and
a pulse-generating circuit receiving the detection signal and outputting the reset signal for restarting the operation of the pulse-width-modulation-signal-generating unit.

17. The liquid crystal display device of claim 16, wherein the detecting circuit compares the driving voltage with a reference voltage, and outputs the detection signal according to the result of the comparison.

18. The liquid crystal display device of claim 14, wherein the pulse-width-modulation-signal-generating unit comprises:
a power-supply-voltage-supplying circuit supplying a power supply voltage, and being turned on or off in response to the reset signal;
a power-on reset circuit being supplied with the power supply voltage, and outputting a power-on reset signal when the power supply voltage is equal to or higher than a specific voltage; and
a signal-generating circuit being turned on or off in response to the power-on reset signal, receiving optical data, and outputting a pulse width modulation signal corresponding to the optical data.

19. The liquid crystal display device of claim 18, wherein the pulse-width-modulation-signal-generating unit further comprises:
an over-voltage protection circuit comparing the driving voltage with the reference voltage and outputting a control signal to the signal-generating circuit according to the result of the comparison, and
the signal-generating circuit is turned on or off in response to the control signal and the power-on reset signal, receives optical data, and outputs a pulse width modulation signal corresponding to the optical data.

20. The liquid crystal display device of claim 19, wherein the over-voltage protection circuit comprises:
a comparing unit comparing the driving voltage and the reference voltage, and outputting the comparison result; and
a storage unit receiving and storing the comparison result, and outputting a control signal corresponding to the stored information.
